(19) United States
(12) Patent Application Publication
(10) Pub. No.: US 2025/0356056 A1
(43) Pub. Date: Nov. 20, 2025

(54) System and method for correcting content errors during processing of an interaction

(71) Applicant: Bank of America Corporation, Charlotte, NC (US)

(72) Inventors: George Albero, Charlotte, NC (US); Naga Vamsi Krishna Akkapeddi, Charlotte, NC (US); Sharath Bonta, Fort Mill, SC (US); Victor A. Hirudhayaraj, Matthews, NC (US); Elijah Clark, Charlotte, NC (US)

(21) Appl. No.: 18/668,859

(22) Filed: May 20, 2024

(51) Int. Cl. G06F 21/64

(52) U.S. Cl. CPC G06F 21/64

(57) ABSTRACT

A method is provided that includes receiving an interaction request that comprises interaction data. The method includes processing the interaction data using software applications in an interaction validation pathway, receiving a content error associated with processing the interaction data in the interaction validation pathway, and determining whether a pre-determined content correction is configured to correct the content error. If not, the method includes generating a content correction using a machine learning model, generating a simulated environment for processing the interaction data with a simulated interaction validation pathway, applying the content correction to the first content error in the simulated environment, and determining whether the content correction corrects the content error in the simulated environment. If so, the method includes generating modified interaction data by applying the first content correction to the first content error, and processing the modified interaction data using the interaction validation pathway.

### TECHNICAL FIELD

This disclosure relates generally to network communications and information security. More particularly, this disclosure relates to a system and method for correcting content errors during processing of an interaction.

### BACKGROUND

Entity servers may perform various operations on interaction requests before recording and posting the interaction. For example, the entity server may perform validations, data processing, and recording.

### SUMMARY

The entity server of the present disclosure processes an interaction request using an interaction validation pathway. The interaction validation pathway may include one or more software applications that are configured to perform various operations, such as validating the interaction data associated with the interaction. One technical problem associated with these operations is that the interaction request may include interaction data that contains one or more content error associated with processing the interaction data in the interaction validation pathway. Exemplary content errors may include, but are not limited to, payload content errors, invoice line-item errors, illegible free text, and code that cannot be interpreted by the software application. In some cases, the content errors are not interpretable by the software applications in the interaction validation pathway and cannot be processed. This causes a failure in the workflow and typically needs manual attention from a system engineer to correct the content error. In cases where the interaction validation pathway has software applications that process the interaction request in series, the content error causes the interaction request to be terminated at the point of failure and the interaction validation pathway may not be continued until the content error is corrected.

The systems and methods described in the present disclosure provide practical applications and technical advantages that overcome the current technical problems described herein. First, the provided systems and methods provide real time detection and correction of content errors in the interaction validation pathway. Second, the provided systems and methods include a memory configured to store a plurality of pre-determined content corrections that are configured to address known content errors. The memory is also operable to store a machine learning model that may generate new content corrections in real time that are configured to correct for the content error in the interaction validation pathway. Third, the provided systems and methods provide a simulated environment for testing either the known, pre-determined content corrections or the new content corrections within a simulated interaction validation pathway in the simulated environment to determine if the content correction will correct for the content error. In this way, the provided systems and methods may reduce, or otherwise eliminate, failures within the interaction validation pathway associated with content errors by correcting the content errors in real time. This provides the practical application and technical advantage of improving the underlying technology by increasing process efficiency by avoid process failures and reducing downtime to manually correct the errors.

In one embodiment, the present disclosure provides a system comprising a memory operable to store an interaction validation pathway comprising one or more software applications configured to validate interaction data associated with an interaction. The memory is further operable to store a plurality of pre-determined content corrections, where each pre-determined content correction in the plurality of pre-determined content corrections is configured to correct a content error associated with the interaction data. The memory is further operable to store a machine learning model. The system comprises a processor operably coupled to the memory. The processor configured to execute the machine learning model. The processor is further configured to receive a request to perform an interaction from a user device, where the request to perform the interaction comprises the interaction data. The processor is configured to process the interaction data using one or more software applications in the interaction validation pathway. The processor is further configured to receive, from the one or more software applications, a first content error associated with processing the interaction data in the interaction validation pathway. The processor is further configured to determine whether one or more of the plurality of pre-determined corrections from the memory are configured to correct the first content error.

If the one or more of the plurality of pre-determined content corrections are not configured to correct the first content error, the processor is further configured to generate a first content correction using the machine learning model, where the machine learning model is trained based at least in part upon the plurality of pre-determined corrections stored in the memory. The processor is configured to generate a simulated environment for processing the interaction data with a simulated interaction validation pathway, apply the first content correction to the first content error in the simulated environment, and determine whether the first content correction corrects the first content error in the simulated environment. If the first content correction is configured to correct the first content error in the simulated environment, the processor is further configured to generate modified interaction data by applying the first content correction to the first content error in the interaction data, and process the modified interaction data using the one or more software applications in the interaction validation pathway.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system according to an embodiment of the present disclosure; and

FIG. 2 illustrates a flowchart of a method according to an embodiment of the present disclosure.

### DETAILED DESCRIPTION

The entity server of the present disclosure processes an interaction request using an interaction validation pathway. The interaction validation pathway may include one or more software applications that are configured to perform various operations, such as validating the interaction data associated with the interaction. One technical problem associated with these operations is that the interaction request may include interaction data that contains one or more content error associated with processing the interaction data in the interaction validation pathway. In some cases, the content errors are not interpretable by the software applications in the interaction validation pathway and cannot be processed. This causes a failure in the workflow and typically needs manual attention from a system engineer to correct the content error. In cases where the interaction validation pathway has software applications that process the interaction request in series, the content error causes the interaction request to be terminated at the point of failure and the interaction validation pathway may not be continued until the content error is corrected.

The systems and methods described in the present disclosure address the current technical problems described herein. First, the provided systems and methods provide real time detection and correction of content errors in the interaction validation pathway. Second, the provided systems and methods include a memory configured to store a plurality of pre-determined content corrections that are configured to address known content errors. The memory is also operable to store a machine learning model that may generate new content corrections in real time that are configured to correct for the content error in the interaction validation pathway. Third, the provided systems and methods provide a simulated environment for testing either the known, pre-determined content corrections or the new content corrections within a simulated interaction validation pathway in the simulated environment to determine if the content correction will correct for the content error. In this way, the provided systems and methods may reduce, or otherwise eliminate, failures within the interaction validation pathway associated with content errors by correcting the content errors in real time.

### System Overview

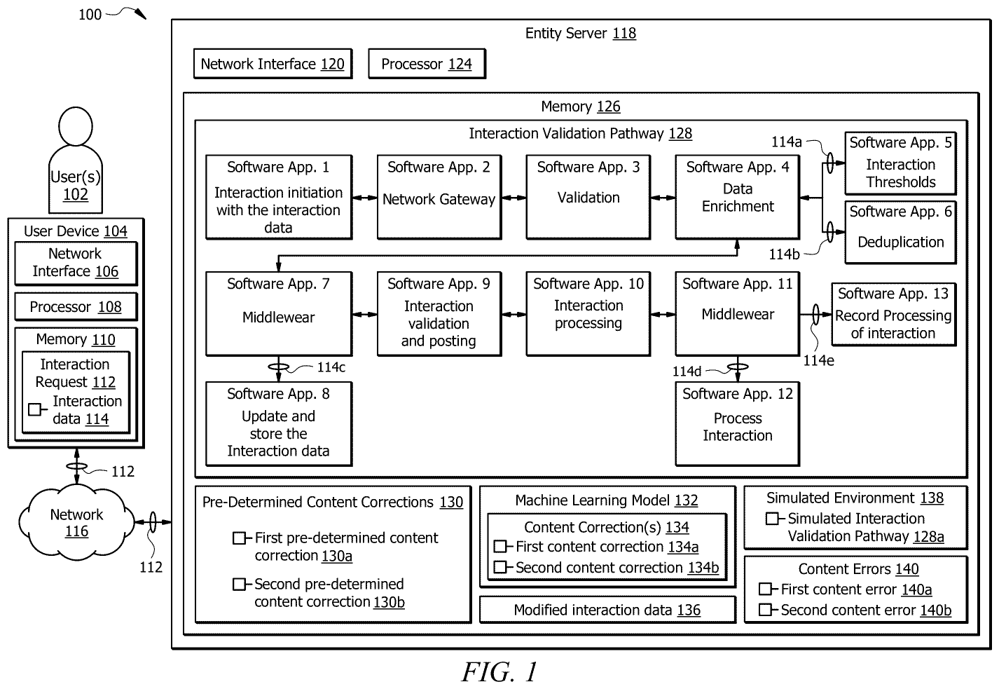

FIG. 1 illustrates a system 100 according to some embodiments of the present disclosure that is configured to validate interaction data 114 associated with an interaction request 112. In some embodiments, the system 100 comprises a user device 104 operable to interact with one or more users 102, a network 116, and an entity server 118. In general, the entity server 118 may receive an interaction request 112 from the one or more user devices 104, where the interaction request 112 includes interaction data 114. The entity server 118 may process the interaction data 114 in an interaction validation pathway 128. The interaction validation pathway 128 includes one or more software applications 1-13 configured to validate the interaction data 114. The entity server 118 may receive one or more content errors 140 associated with processing the interaction data 114 in the interaction validation pathway 128. The entity server 118 is configured to determine whether one or more of a plurality of pre-determined content corrections 130 stored in a memory 126 are configured to correct the one or more content errors 140. If the one or more of the plurality of pre-determined content corrections 130 are not configured to correct the first content error 140a, the entity server 118 is configured to generate one or more content correction 134 using a machine learning model 132, where the machine learning model 132 is trained based at least in part upon the plurality of pre-determined corrections 130 stored in the memory 126. The entity server 118 is configured to generate a simulated environment 138 for processing the interaction data 114 with a simulated interaction validation pathway 128a, and apply the one or more content correction 134 to the one or more content errors 140 in the simulated environment 138. The entity server 118 is configured to determine whether the one or more content corrections 134 generated by the machine learning model 132 corrects for the one or more content errors 140 in the simulated environment 138. If the one or more content corrections 134 corrects for the one or more content error 140 in the simulated environment 138, the entity server 118 is configured to generated modified interaction data 136 by applying the one or more content correction 134 to the one or more content error 140 in the interaction data 114, and process the modified interaction data 136 using the one or more software applications 1-13 in the interaction validation pathway 128.

### System Components of FIG. 1

### User Device

User device 104 is generally any device configured to interact with one or more users 102. The user device 104 may be a mobile phone, a smartphone, an electronic tablet device, or a computer (e.g., personal computer, desktop, workstation, laptop). In some embodiments, the user device 104 is in signal communication with the entity server 118 via the network 116. The user device 104 is generally configured to receive interaction data 114 from the one or more users 102 to generate the interaction request 112. In a particular embodiment, the interaction request 112 may a comprise a transaction request, such as a request to sell a customer product in a new jurisdiction. In a particular embodiment, the interaction data 114 comprises an invoice, a request to fulfill a customer product, or the like.

The user device 104 may include a network interface 106, a processor 108, and a memory 110. The network interface 106 is configured to enable wired and/or wireless communications between the network 116 and the user device 104, as well as other components in the system 100. Suitable network interfaces 106 include an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The network interface 106 may be configured to use any suitable type of communication protocol as would be appreciated by one of ordinary skill in the art.

The memory 110 may be volatile or non-volatile and may comprise read-only memory (ROM), random-access memory (RAM), ternary content-addressable memory (TCAM), dynamic random-access memory (DRAM), and static random-access memory (SRAM). The memory 110 may include one or more of a local database, cloud database, network-attached storage (NAS), etc. The memory 110 comprises one or more disks, tape drives, or solid-state drives, and may be used as an over-flow data storage device, to store programs when such programs are selected for execution, and to store instructions and data that are read during program execution. The memory 110 may store the interaction request 112, which may include the interaction data 114 along with any other data, instructions, logic, rules, or code operable to implement the function(s) described herein when executed by processor 108.

In one non-limiting example, the interaction request 112 may be a request from the user device 104 to process an invoice to pay a vender. In this example, the interaction data 114 may comprise the invoice having a payload. The payload of the invoice may have a header amount and a plurality of line items associated with the transaction. The line items in the interaction data may include, but is not limited to, numerical values, free text describing the transaction, images, source code, or combinations thereof. The entity server 118 may validate the interaction data 114 prior to recording and processing the interaction request 112. In another non-limiting example, the interaction request 112 may be a request by the user device 104 to sell an existing or new customer product in a new jurisdiction. For example, the customer product may currently be sold in a first jurisdiction (e.g., North Carolina) and the interaction request 112 may be requesting to sell the customer product in a second jurisdiction (e.g., South Carolina). In this example, the interaction data 114 may include numerical values associated with the cost and specifications of the customer product, free text describing the customer product, images of the product, source code associated with the product, information associated with the company selling the product in the first jurisdiction, and information associated with the company selling the product in the second jurisdiction. In this example, the entity server 118 may audit the interaction data 114 to verify that the company in the second jurisdiction is associated with the company in the first jurisdiction (e.g., verify the company is a child company and is an active company that exists in South Carolina before processing the interaction).

The processor 108 of the user device 104 is configured to send the interaction request 112 to the entity server 118 via the network 116 to process the interaction data 114. The interaction request 112 may include the interaction data 114. The processor 108 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, the processor 108 may be implemented in cloud devices, servers, virtual machines, and the like. The processor 108 may be a programmable logic device, a microcontroller, a microprocessor, or any suitable combination of the preceding. The processor 108 is configured to process data and may be implemented in hardware or software. For example, the processor 108 may be 8-bit, 16-bit, 32-bit, 64-bit, or of any other suitable architecture. The processor 108 may include an arithmetic logic unit (ALU) for performing arithmetic and logic operations, registers the supply operands to the ALU and store the results of ALU operations, and a control unit that fetches instructions from memory 110 and executes them by directing the coordinated operations of the ALU, registers and other components. The processor 108 is configured to implement various instructions described herein. For example, the processor 108 is configured to execute instructions from the memory 110 to implement the functions of the processor 108. In this way, processor 108 may be a special-purpose computer designed to implement the functions disclosed herein. In an embodiment, the processor 108 is implemented using logic units, FPGAs, ASICs, DSPs, or any other suitable hardware.

### Network

Network 116 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 116 may be configured to support any suitable type of communication protocol as would be appreciated by one of ordinary skill in the art. In some embodiments, the network 116 facilitates the transfer of data between the user device 104 and the entity server 118.

### Entity Server

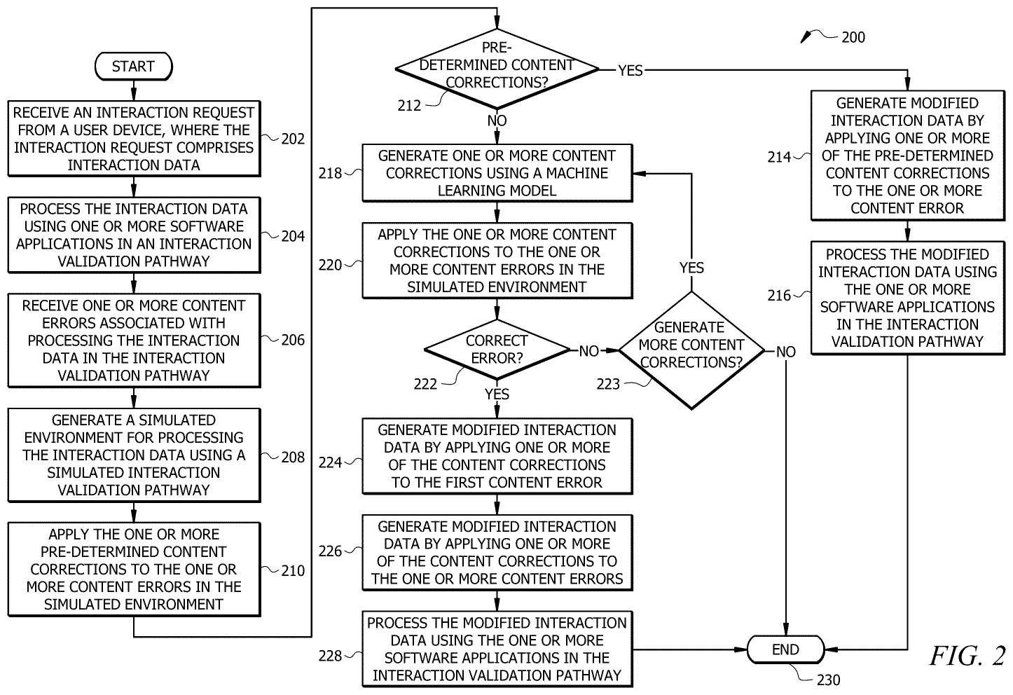

The entity server 118 comprises a processor 124 operably coupled with a network interface 120 and a memory 126. The processor 124 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 124 may be a programmable logic device, a microcontroller, a microprocessor, or any suitable number and combination of the preceding. The one or more processors are configured to process data and may be implemented in hardware or software. For example, the processor 124 may be 8-bit, 16-bit, 32-bit, 64-bit, or of any other suitable architecture. The processor 124 may include an arithmetic logic unit (ALU) for performing arithmetic and logic operations. The processor 124 may register the supply operands to the ALU and store the results of ALU operations. The processor 124 may further include a control unit that fetches instructions from memory and executes them by directing the coordinated operations of the ALU, registers, and other components. The one or more processors are configured to implement various software instructions. In this way, processor 124 may be a special-purpose computer designed to implement the functions disclosed herein. In an embodiment, the processor 124 is implemented using logic units, FPGAs, ASICs, DSPs, or any other suitable hardware. The processor 124 is configured to operate as described in FIGS. 1-2. For example, the processor 124 may be configured to perform one or more operations of the operational flow 200 as described in FIG. 2.

The network interface 120 is configured to enable wired and/or wireless communications between the entity server 118 the network 116 and the user device 104. Suitable network interfaces 120 include an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The network interface 120 may be configured to use any suitable type of communication protocol as would be appreciated by one of ordinary skill in the art.

The memory 126 may be volatile or non-volatile and may comprise read-only memory (ROM), random-access memory (RAM), ternary content-addressable memory (TCAM), dynamic random-access memory (DRAM), and static random-access memory (SRAM). The memory 126 may include one or more of a local database, cloud database, network-attached storage (NAS), etc. The memory 126 comprises one or more disks, tape drives, or solid-state drives, and may be used as an over-flow data storage device, to store programs when such programs are selected for execution, and to store instructions and data that are read during program execution. The memory 126 may comprise non-transitory computer-readable medium. The memory 126 may store any of the information described in FIGS. 1-2 along with any other data, instructions, logic, rules, or code operable to implement the function(s) described herein when executed by processor 124.

The memory may be operable to store the interaction validation pathway 128 that comprises one or more software applications 1-13 configured to validate the interaction data 114 associated with the interaction request 112. The interaction validation pathway 128 may include various portions that process the interaction request in series (e.g., software applications 1-4, 7-11) and/or in parallel (e.g., software applications 5, 6, 8, 12-13). The interaction validation pathway 128 may include a first software application 1 that is configured to receive the interaction request 112 from the user device 104 and initiate processing of the interaction.

The interaction validation pathway 128 may include a second software application 2 configured in series with the first software application 1. The second software application 2 may include a network gateway. The network gateway may include a firewall operating according to a defined set of rules and/or security thresholds that permit or deny certain types of data to flow into the entity server 118. The rules are configured to allow desirable data to flow between the entity server 118 and the network 116, and the rules may exclude any network traffic that may pose a security threat to the entity server 118. Examples of data that should be excluded includes malware, viruses, worms, malicious code, certain cookies, spam, blocked websites, and the like. Software application 2 may include a firewall that includes, but is not limited to, packet filters, circuit-level gateways, application layer filters, a stateful inspection firewall, or next-generation firewall.

The interaction validation pathway 128 may include a third software application 3 configured in series with the second software application 2. The third software application 3 may be configured to validate portions of the interaction data 114. For example, the third software application 3 may process the interaction data 114 to verify whether the company or vender associated with the interaction request 112 exists. In another example, the third software application 3 may process the interaction data 114 to verify that the header amount is consistent with the line-item values. The interaction validation pathway 128 may include a fourth software application 4 configured in series with the third software application 3. The fourth software application 4 may be configured to perform one or more data enrichment operations to the interaction data 114. For example, the fourth software application 4 may process the line-items in the invoice to interpret source code associated with the line-items. For example, the fourth software application 4 may determine if any company code is used in the interaction data 114 and determine if any product codes are associated with the interaction request 112. The fourth software application 4 may process the line-items and header to determine the type of interaction request 112 and any account number associated with the interaction data 114. The fourth software application 4 may also be configured to branch the interaction data 114 into a first interaction data set 114a and a second interaction data set 114b. The first interaction data set 114a and the second interaction data set 114b may be duplicative data.

The interaction validation pathway 128 may include a fifth software application 5 configured to receive the first interaction data set 114a from the fourth software application 4 in parallel. The fifth software application 5 may be configured to process the first interaction data set 114a based on an interaction threshold. For example, the interaction threshold may be a pre-consent threshold that specifies a maximum amount of money that the entity server may approve for a particular invoice. The entity server 118 may terminate the interaction request 112 if the interaction threshold is exceeded. The interaction validation pathway 128 may include a sixth software application 6 configured to receive the second interaction data set 114b from the fourth software application 4 in parallel. The sixth software application 6 is configures to process the second interaction data set 114b for duplicate invoices. For example, the sixth software application 6 may check and see if an invoice number associated with the interaction data 114 has been processed by the entity server 118 and terminate the interaction request 112 if a duplicate is identified. The fourth software application 4 may receive the results from the fifth software application 5 and the sixth software application 6 in parallel and incorporate the results into the interaction data 114 before sending the interaction data 114 to the seventh software application 7.

The interaction validation pathway 128 may include a seventh software application 7. The seventh software application 7 may be configured to receive the interaction data 114 from the fourth application software 4 in series. The seventh software application 7 may process the interaction data 114 with middleware. For example, the seventh software application 7 may process the interaction data 144 to identify information to perform the interaction and may remove any information not associated with the interaction. The seventh software application 7 may be configured to branch the interaction data 114 into a third interaction data set 114c. The third interaction data set 114c may be duplicative of the interaction data 114 received by the software application 7. The interaction validation pathway 128 may include an eighth software application 8 that is configured to receive the third interaction data set 114c in parallel. The eighth software application 8 may be configured record the interaction data 114 in the memory 126 and continuously update the interaction data 114 based on the interaction state.

The interaction validation pathway 128 may include a ninth software application 9. The ninth software application 9 may receive the interaction data 114 from the seventh software application 7 in series. The ninth software application 9 may be configured to validate and post the interaction data 114 following the middleware operations. For example, the ninth software application may process the interaction data 114 to confirm the line-items, identify and remove duplicate information in the interaction data 114, and validate source code in the interaction data 114. The interaction validation pathway 128 may include a tenth software application 10. The tenth software application 10 may be configured to receive the interaction data 114 from the ninth software application 9. The tenth software application 10 may be configured execute the interaction request 112. For example, the entity server 118 may be configured to process the payment of the invoice, process a payment associated with the new customer product, or approve the audit of the new customer product.

The interaction validation pathway 128 may include an eleventh software application 11. The eleventh software application 11 may be configured to receive the interaction data 114 from the tenth software application 10 in series. In some embodiments, the entity server 118 may not be configured to execute the interaction and may need to coordinate with a third-party server (e.g., coordinate with a third-party banking institution to process the payment). The eleventh software application 11 may process the interaction data 114 with middleware to coordinate the interaction with the third-party server. For example, the eleventh software application 11 may be configured to branch the interaction data 114 into a fourth interaction data set 114d and a fifth interaction data set 115e. The fourth interaction data set 114d and the fifth interaction data set 115e may be duplicates of the interaction data set 114 as it exists in the eleventh software application 11. The interaction validation pathway 128 may include a twelfth software application 12 configured to receive the fourth interaction data set 114d from the eleventh software application 11 in parallel. The twelfth software application may be configured to send the fourth interaction data set 114d to the third-party server to execute the interaction. The interaction validation pathway 128 may include a thirteenth software application 13. The thirteenth software application 13 may be configured to receive the fifth interaction data set 115e from the eleventh software application 11 in parallel. The thirteenth software application 13 is configured to store the fifth interaction data set 115e in the memory 126, and may be configured to record that the interaction is processed by the twelfth software application 12.

As discussed above, the one or more software applications 1-13 may not be able to process the interaction request 112 due to one or more content error 140 (e.g., at least a first content error 140a and/or a second content error 140b) that is present in the interaction data 114. In some embodiments, the one or more software applications 1-13 may identify and send the one or more content error 140 associated with the interaction data 114 in the interaction validation pathway 128 to the entity server 118. The content error 140 may be any error associated with the interaction data 114 that prevents the one or more software applications 1-13 from processing the interaction request 112. Exemplary content errors 140 may include, but are not limited to, free text that is not interpretable by the one or more software applications 1-13, source code in the one or more line-items that is not interpretable by the one or more software applications 1-13, images that are not interpretable by the one or more software applications 1-13, a header amount that does not match the line-items in the invoice, errors in source code associated with the customer product, an error in branching the interaction data into the one or more interaction data sets 114a-e, or combinations thereof. The one or more content errors 140 may be stored in the memory 126.

The memory 126 may be operable to store a plurality of pre-determined content corrections 130 (e.g., a first pre-determined content correction 130a, a second pre-determined content correction 130b, etc.). The plurality of pre-determined content corrections are configured to correct for known content errors 140s. For example, the pre-determined content corrections 130 may include, but is not limited to, source code that is configured to interpret the content errors 140 (e.g., free text or images that are not by the one or more software applications 1-13), source code that fixes errors associated with line-items, source code that fixes errors in the source code of the interaction data 114, customer product codes that are missing from the interaction data 114, source code that adjusts the header amount to match the line-items in the invoice, source code that corrects an error in branching the interaction data into the one or more interaction data sets 114a-e, or combinations thereof.

The memory 126 may be operable to store a machine learning model 132. The machine learning model 132 may be configured to generate one or more content corrections 134 that are configured to correct the one or more content errors 140 present in the interaction data 114. The machine learning model 132 may comprise a support vector machine, neural network, random forest, or k-means clustering. In another example, the machine learning model 132 may be implemented by a plurality of neural network (NN) layers, Convolutional NN (CNN) layers, Long-Short-Term-Memory (LSTM) layers, Bi-directional LSTM layers, or Recurrent NN (RNN) layers. In another example, the machine learning model 132 may be implemented by Natural Language Processing (NLP). In some embodiments, the machine learning model 132 may be trained based on feature variables, such as the plurality of pre-determined content corrections 130, as well as other sources such as context information present in the interaction data 114, the interaction type, the location of the error in the interaction validation pathway 128, payload content of the interaction data 114, or combinations thereof. The content corrections 134 may include source code that is configured to interpret the content errors 140 (e.g., free text or images that are not by the one or more software applications 1-13), source code that fixes errors in line-items, source code that fixes errors in the source code of the interaction data 114, customer product codes that are missing from the interaction data 114, source code that adjusts the header amount to match the line-items in the invoice, source code that corrects an error in branching the interaction data into the one or more interaction data sets 114a-e, or combinations thereof. The content corrections 134 (e.g., a first content correction 134a, a second content correction 134b, etc.) may be stored in the memory 126. The processor 124 may be configured to generate a simulated environment 138 for processing the interaction data 114 with the one or more content corrections 134 in a simulated interaction validation pathway 128a. For example, the processor 124 may be configured to apply the one or more content corrections 134 to interaction data 114 and process the interaction request 112 through the simulated interaction validation pathway 128a in the simulated environment 138 to determine whether the one or more content corrections 134 corrects the content error 140. The processor 124 may determine that the one or more content corrections are successful if the one or more software applications 1-13 are configured to process the interaction request 112. If successful, the processor 124 may generate modified interaction data 136 by applying the one or more content correction 134 to the one or more content errors 140 in the interaction data 114, and process the modified interaction data using the one or more software applications 1-13. The modified interaction data 136 may be stored in the memory 126.

### Example Operation

FIG. 2 illustrates an operational flow 200 according to one embodiment of the present disclosure. The operational flow 200 can logically be described in three parts. The first part includes operations 202-212, which generally includes receiving on the entity server 118 an interaction request 112 that includes interaction data 114 from a user device, processing the interaction data 114 using one or more software applications 1-13 in the interaction validation pathway 128, and receiving on the entity server 118 one or more content errors 140 associated with processing the interaction data 114 in the interaction validation pathway 128 from the one or more software applications 1-13. The first part further includes generating a simulated environment 138 for processing the interaction data 114 using a simulated interaction validation pathway 128a and applying the one or more pre-determined content corrections 130 to the one or more content errors 140 in the simulated interaction validation pathway 128a. If the entity server 118 determines that the one or more pre-determined content corrections 130 corrects the one or more content errors 140 in the simulated environment 138, then the operational flow 200 proceeds to the second part.

The second part includes generating the modified interaction data 136 by applying the one or more pre-determined content corrections 130 to the one or more content errors 140 in the interaction data 114 if the entity server 118 determines that the one or more pre-determined content corrections 130 corrects the one or more content errors 140 in the simulated environment 138. The second part further includes processing the modified interaction data 136 using the one or more software applications 1-13 in the interaction validation pathway 128 in a real word environment.

If the entity server 118 determines that the one or more pre-determined content corrections 130 does not correct for the one or more content errors 140 in the simulated environment, then the operational flow 200 proceeds to the third part. The third part includes generating one or more content correction 134 using a machine learning model 132, applying the one or more content correction 134 to the one or more content error 140 in the simulated interaction validation pathway 128a in the simulated environment 138. The third part further includes determining whether the one or more content correction 134 generated by the machine learning model 132 corrects for the one or more content error 140 in the simulated environment 138. If the one or more content correction 134 corrects for the one or more content error 140 in the simulated environment 138, the third part includes generating modified interaction data 136 by applying the one or more content correction 134 to the one or more content error 140 in the interaction data 114, and processing the modified interaction data 136 using the one or more software applications 1-13 in the interaction validation pathway 128.

At operation 202, the operational flow 200 includes receiving the interaction request 112 from the user device 104, where the interaction request 112 comprises the interaction data 114. In one non-limiting example, the interaction request 112 may be a request from the user device 104 to process an invoice to pay a vender. In this example, the interaction data 114 may comprise the invoice having a payload. The payload of the invoice may have a header amount and a plurality of line items associated with the transaction. The line items in the interaction data may include, but is not limited to, numerical values, free text describing the transaction, images, source code, or combinations thereof. The entity server 118 may validate the interaction data 114 prior to recording and processing the interaction request 112. In another non-limiting example, the interaction request 112 may be a request by the user device 104 to sell an existing or new customer product in a new jurisdiction. For example, the customer product may currently be sold in a first jurisdiction (e.g., North Carolina) and the interaction request 112 may be requesting to sell the customer product in a second jurisdiction (e.g., South Carolina). In this example, the interaction data 114 may include numerical values associated with the cost and specifications of the customer product, free text describing the customer product, images of the product, source code associated with the product, information associated with the company selling the product in the first jurisdiction, and information associated with the company selling the product in the second jurisdiction. In this example, the entity server 118 may audit the interaction data 114 to verify that the company in the second jurisdiction is associated with the company in the first jurisdiction (e.g., verify the company is a child company and is an active company that exists in South Carolina before processing the interaction).

At operation 204, the operational flow 200 includes processing the interaction data using the one or more software applications 1-13 in the interaction validation pathway 128, as described above. At operation 206, the operational flow 200 includes receiving one or more content error 140 associated with processing the interaction data 114 in the interaction validation pathway 128. For example, the one or more software applications 1-13 may not be able to process the interaction request 112 due to one or more content error 140a (e.g., at least a first content error 140a and/or a second content error 140b) that is present in the interaction data 114. In some embodiments, the one or more software applications 1-13 may identify and send the one or more content error 140 associated with the interaction data 114 in the interaction validation pathway 128 to the entity server 118. The content error 140 may be any error associated with the interaction data 114 that prevents the one or more software applications 1-13 from processing the interaction request 112. Exemplary content errors 140 may include, but are not limited to, free text that is not interpretable by the one or more software applications 1-13, source code in the one or more line-items that is not interpretable by the one or more software applications 1-13, images that are not interpretable by the one or more software applications 1-13, a header amount that does not match the line-items in the invoice, errors in source code associated with the customer product, an error in branching the interaction data 114 into the one or more interaction data sets 114a-e, or combinations thereof.

At operation 208, the operational flow 200 includes generating a simulated environment 138 for processing the interaction data 114 with a simulated interaction validation pathway 128a. The simulated environment 138 may be created by the processor 124 to test various content corrections to determine if the content corrections correct for the content errors 140 without having to perform the interaction in a real-world environment (i.e., where it is recorded and processed). The simulated interaction validation pathway 128a may include the same software applications 1-13 as the interaction validation pathway 128 and may operate the same within the simulated environment 138.

At operation 210, the operational flow 200 includes applying the one or more pre-determined content corrections 130 to the one or more content error 140 in the simulated environment. For example, the pre-determined content corrections 130 may include source code that is configured to interpret the content errors 140 (e.g., free text or images that are not by the one or more software applications 1-13), source code that fixes errors in line-items, source code that fixes errors in the source code of the interaction data 114, customer product codes that are missing from the interaction data 114, source code that adjusts the header amount to match the line-items in the invoice, source code that fixes an error in branching the interaction data 114 into the one or more interaction data sets 114a-e, or combinations thereof.

At decision block 212, the operational flow 200 includes determining whether the one or more pre-determined content corrections 130 from the memory 126 are configured to correct the one or more content errors 140. The entity server 118 may determine that the pre-determined content corrections 130 correct the one or more content errors 140 if the one or more software applications 1-13 are able to process the interaction request 112 within the simulated environment 138. If the pre-determined content corrections 130 correct the one or more content errors 140, the operational flow 200 proceeds to operation 214. If the one or more software applications 1-13 are not able to process the interaction request 112 within the simulated environment 138, and the simulated interaction validation pathway 128a generate one or more content errors 140, then the entity server 118 determines that the pre-determined content corrections 130 do not correct the one or more content errors 140, and the operational flow 200 proceeds to operation 218.

At operation 214 in response to determining that the pre-determined content corrections 130 correct the one or more content errors 140, the operational flow 200 includes generating modified interaction data 136 by applying the one or more of the pre-determined content corrections 130 to the one or more content error 140 in the interaction data 114. For example, this may include applying the source code to the content errors 140 such that the one or more software applications 1-13 are able to interpret the content errors (e.g., free text or images that are not by the one or more software applications 1-13), applying source code that fixes errors associated with line-items, applying source code that fixes errors in the source code of the interaction data 114, applying customer product codes that are missing from the interaction data 114, applying source code that adjusts the header amount to match the line-items in the invoice, applying source code that corrects an error in branching the interaction data into the one or more interaction data sets 114a-e, or combinations thereof. At operation 216, the operational flow 200 includes processing the modified interaction data 136 using the one or more software applications 1-13 in the interaction validation pathway 128.

At operation 218, in response to determining that the pre-determined content corrections 130 do not correct the one or more content errors 140, the operational flow 200 includes generating one or more content corrections 134 using the machine learning model 132. The machine learning model 132 may be configured to generate one or more content corrections 134 that are configured to correct the one or more content errors 140 present in the interaction data 114. The machine learning model 132 may comprise a support vector machine, neural network, random forest, or k-means clustering. In another example, the machine learning model 132 may be implemented by a plurality of neural network (NN) layers, Convolutional NN (CNN) layers, Long-Short-Term-Memory (LSTM) layers, Bi-directional LSTM layers, or Recurrent NN (RNN) layers. In another example, the machine learning model 132 may be implemented by Natural Language Processing (NLP). In some embodiments, the machine learning model 132 may be trained based on feature variables, such as the plurality of pre-determined content corrections 130, as well as other sources such as context information present in the interaction data 114, the interaction type, the location of the error in the interaction validation pathway 128, payload content of the interaction data 114, or combinations thereof.

At operation 220, the operational flow 200 includes applying the one or more content corrections 134 to the one or more content errors 140 in the simulated interaction validation pathway 128a in the simulated environment 138. For example, the one or more content corrections 134 may include source code that is configured to interpret the content errors 140 (e.g., free text or images that are not by the one or more software applications 1-13), source code that fixes errors in line-items, source code that fixes errors in the source code of the interaction data 114, customer product codes that are missing from the interaction data 114, source code that adjusts the header amount to match the line-items in the invoice, source code that fixes an error in branching the interaction data into the one or more interaction data sets 114a-e, or combinations thereof.

At decision block 222, the operational flow 200 includes determining whether the one or more content corrections 134 from the machine learning model 132 are configured to correct the one or more content errors 140. The entity server 118 may determine that the one or more content corrections 134 correct the one or more content errors 140 if the one or more software applications 1-13 are able to process the interaction request 112 within the simulated environment 138. If the one or more content corrections 134 correct the one or more content errors 140, the operational flow 200 proceeds to operation 224, which is described below. If the one or more software applications 1-13 are not able to process the interaction request 112 within the simulated environment 138, and the simulated interaction validation pathway 128a generate one or more content errors 140, then the entity server 118 determines that the one or more content corrections 134 do not correct the one or more content errors 140. In this case, the operational flow 200 may proceed to decision block 223.

At decision block 223, the operational flow 200 determines whether the entity server 118 should generate another content correction 134 using the machine learning model 132 by returning to operation 218. The entity server 118 may have a threshold number of content corrections 134 that it generates using the machine learning model 132 before proceeding to end 230 the operational flow 200. For example, if the entity server 118 does not generate a content correction 134 that corrects for the one or more content errors 140 after at least ten content corrections 134, or at least one hundred, to less than one thousand, or less than ten thousand content corrections 134, then the decision block may proceed to end 230 the operational flow 200 and generate an indication that manual review should be initiated by a user.

If the operational flow 200 returns to operation 218, the operational flow 200 may continue to generate content corrections 134 using the machine learning model 132. For example, the machine learning model 132 may generate a first content correction 134a and determine that the first content correction 134a is not configured to correct for a first content error 140a in the simulated environment 138. In response, the entity server 118 may generate a second content correction 134b using the machine learning model 132, and apply the second content correction 134b to the first content error 140a in the simulated environment 138. If the entity server 118 determines that the second content correction 134b corrects for the first content error 140a, the operational flow 200 may proceed to operation 224. If the entity server 118 determines that the second content correction 134b does not correct for the first content error 140a, then operations 218-220 may be repeated any number of times up to the threshold number until the machine learning model 132 generates a correction.

At operation 224 in response to determining that the one or more content corrections 134 correct for the one or more content error 140, the operational flow 200 includes storing the one or more content correction in the memory 126 with the plurality of pre-determined content corrections 130. In this way, the entity server 118 may continuously update the database of pre-determined content corrections 130 to improve the results generated from the machine learning model 132.

At operation 226, the operational flow 200 includes generating modified interaction data 136 generating modified interaction data 136 by applying the one or more content corrections 134 to the one or more content error 140 in the interaction data 114. For example, this may include applying the source code to the content errors 140 such that the one or more software applications 1-13 are able to interpret the content errors (e.g., free text or images that are not by the one or more software applications 1-13), applying source code that fixes errors associated with line-items, applying source code that fixes errors in the source code of the interaction data 114, applying customer product codes that are missing from the interaction data 114, applying source code that adjusts the header amount to match the line-items in the invoice, applying source code that corrects an error in branching the interaction data into the one or more interaction data sets 114a-e, or combinations thereof. At operation 228, the operational flow 200 includes processing the modified interaction data 136 using the one or more software applications 1-13 in the interaction validation pathway 128.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1. A system comprising:
a memory operable to store:
an interaction validation pathway comprising one or more software applications configured to process interaction data associated with an interaction request;
a plurality of pre-determined content corrections, wherein each pre-determined content correction in the plurality of pre-determined content corrections is configured to correct a content error associated with the interaction data; and
a machine learning model; and
a processor operably coupled to the memory, the processor configured to execute the machine learning model, the processor further configured to:
receive the interaction request from a user device, wherein the interaction request comprises the interaction data;
process the interaction data using the one or more software applications in the interaction validation pathway;
receive, from the one or more software applications, a first content error associated with processing the interaction data in the interaction validation pathway; and
determine whether one or more of the plurality of pre-determined content corrections from the memory are configured to correct the first content error, wherein if the one or more of the plurality of pre-determined content corrections are not configured to correct the first content error, the processor is further configured to:
generate a first content correction using the machine learning model, wherein the machine learning model is trained based at least in part upon the plurality of pre-determined content corrections stored in the memory;
generate a simulated environment for processing the interaction data with a simulated interaction validation pathway;
apply the first content correction to the first content error in the simulated environment; and
determine whether the first content correction corrects the first content error in the simulated environment, wherein if the first content correction is configured to correct the first content error in the simulated environment, the processor is further configured to:
generate modified interaction data by applying the first content correction to the first content error in the interaction data; and
process the modified interaction data using the one or more software applications in the interaction validation pathway.

2. The system of claim 1, wherein after determining that the first content correction is configured to correct the first content error in the simulated environment, the processor is further configured to:
store the first content correction in the memory with the plurality of pre-determined content corrections.

3. The system of claim 1, wherein determining whether the one or more of the plurality of pre-determined content corrections from the memory are configured to correct the first content error further comprises using the processor to:
apply the one or more of the plurality of pre-determined content corrections to the first content error in the simulated environment, wherein if the one or more of the plurality of pre-determined content corrections is configured to correct the first content error in the simulated environment, the processor is configured to:
generate the modified interaction data by applying the one or more of the plurality of pre-determined content corrections to the first content error; and
process the modified interaction data using the one or more software applications in the interaction validation pathway;
wherein if the one or more of the plurality of pre-determined content corrections is not configured to correct the first content error in the simulated environment, the processor is configured to generate the first content correction using the machine learning model.

4. The system of claim 1, wherein if the first content correction generated by the machine learning model is not configured to correct the first content error in the simulated environment, the processor is further configured to:
generate a second content correction using the machine learning model;
apply the second content correction to the first content error in the simulated environment; and
determine whether the second content correction is configured to correct the first content error in the simulated environment, wherein if the second content correction is configured to correct the first content error in the simulated environment, the processor is further configured to:
generate the modified interaction data by applying the second content correction to the first content error in the interaction data; and
process the modified interaction data using the one or more software applications in the interaction validation pathway.

5. The system of claim 4, wherein after determining that the second content correction is configured to correct the first content error in the simulated environment, the processor is further configured to:
store the second content correction in the memory with the plurality of pre-determined content corrections.

6. The system of claim 1, wherein a first portion of the one or more software applications in the interaction validation pathway are configured to process the interaction data in series and a second portion of the one or more software applications are configured to process the interaction data in parallel.

7. The system of claim 1, wherein the interaction validation pathway comprises:
a first software application configured to receive the interaction data, wherein the first software application is configured to branch the interaction data into a first interaction data set and a second interaction data set;
a second software application configured to receive the first interaction data set from the first software application; and
a third software application configured to receive the second interaction data set.

8. The system of claim 7, wherein the first content error is associated with branching the interaction data into the first interaction data set and the second interaction data set;
wherein the first content correction in the simulated environment is configured to allow the first software application to branch the first interaction data into the first interaction data set and the second interaction data set.

9. A method comprising:
receiving, on an entity server, an interaction request from a user device, wherein the interaction request comprises interaction data;
processing, using the entity server, the interaction data using one or more software applications in an interaction validation pathway, wherein the one or more software applications are configured to process the interaction data associated with the interaction request;
receiving, on the entity server, a first content error associated with processing the interaction data in the interaction validation pathway; and
determining whether one or more of a plurality of pre-determined content corrections are configured to correct the first content error, wherein if the one or more of the plurality of pre-determined content corrections are not configured to correct the first content error, the method further comprises:
generating a first content correction using a machine learning model, wherein the machine learning model is trained based at least in part upon the plurality of pre-determined content corrections;
generating a simulated environment for processing the interaction data with a simulated interaction validation pathway;
applying the first content correction to the first content error in the simulated environment; and
determining whether the first content correction corrects the first content error in the simulated environment, wherein if the first content correction is configured to correct the first content error in the simulated environment, the method further comprises:
generating modified interaction data by applying the first content correction to the first content error in the interaction data; and
processing the modified interaction data using the one or more software applications in the interaction validation pathway.

10. The method of claim 9, wherein after determining that the first content correction is configured to correct the first content error in the simulated environment, the method further comprises:
storing the first content correction in a memory with the plurality of pre-determined content corrections.

11. The method of claim 9, wherein determining whether the one or more of the plurality of pre-determined content corrections are configured to correct the first content error further comprises:
applying the one or more of the plurality of pre-determined content corrections to the first content error in the simulated environment, wherein if the one or more of the plurality of pre-determined content corrections is configured to correct the first content error in the simulated environment, the method further comprises:
generating the modified interaction data by applying the one or more of the plurality of pre-determined content corrections to the first content error; and
processing the modified interaction data using the one or more software applications in the interaction validation pathway;
wherein if the one or more of the plurality of pre-determined content corrections is not configured to correct the first content error in the simulated environment, the method includes generating the first content correction using the machine learning model.

12. The method of claim 9, wherein if the first content correction generated by the machine learning model is not configured to correct the first content error in the simulated environment, the method further comprises:
generating a second content correction using the machine learning model;
applying the second content correction to the first content error in the simulated environment; and
determining whether the second content correction is configured to correct the first content error in the simulated environment, wherein if the second content correction is configured to correct the first content error in the simulated environment, the method further comprises:
generating the modified interaction data by applying the second content correction to the first content error in the interaction data; and
processing the modified interaction data using the one or more software applications in the interaction validation pathway.

13. The method of claim 12, wherein after determining that the second content correction is configured to correct the first content error in the simulated environment, the method further comprises:
storing the second content correction in a memory with the plurality of pre-determined content corrections.

14. The method of claim 9, wherein a first portion of the one or more software applications the interaction validation pathway are configured to process the interaction data in series and a second portion of the one or more software applications are configured to process the interaction data in parallel.

15. The method of claim 9, wherein the interaction validation pathway comprises:
a first software application configured to receive the interaction data, wherein the first software application is configured to branch the interaction data into a first interaction data set and a second interaction data set;
a second software application configured to receive the first interaction data set from the first software application; and
a third software application configured to receive the second interaction data set.

16. The method of claim 15, wherein the first content error is associated with branching the interaction data into the first interaction data set and the second interaction data set,
wherein the first content correction in the simulated environment is configured to allow the first software application to branch the interaction data into the first interaction data set and the second interaction data set.

17. A non-transitory computer-readable medium that stores instructions that when executed by a processor, causes the processor to:
receive an interaction request from a user device, wherein the interaction request comprises interaction data;
process the interaction data using one or more software applications in an interaction validation pathway, wherein the one or more software applications are configured to process the interaction data associated with the interaction request;
receive, from the one or more software applications, a first content error associated with processing the interaction data in the interaction validation pathway; and
determine whether one or more of a plurality of pre-determined content corrections are configured to correct the first content error, wherein if the one or more of the plurality of pre-determined content corrections are not configured to correct the first content error, the processor is further configured to:
generate a first content correction using a machine learning model, wherein the machine learning model is trained based at least in part upon the plurality of pre-determined content corrections;
generate a simulated environment for processing the interaction data with a simulated interaction validation pathway;
apply the first content correction to the first content error in the simulated environment; and
determine whether the first content correction corrects the first content error in the simulated environment, wherein if the first content correction is configured to correct the first content error in the simulated environment, the processor is further configured to:
generate modified interaction data by applying the first content correction to the first content error in the interaction data; and
process the modified interaction data using the one or more software applications in the interaction validation pathway.

18. The non-transitory computer-readable medium of claim 17, wherein after determining that the first content correction is configured to correct the first content error in the simulated environment, the instructions when executed by the processor cause the processor to:
store the first content correction in a memory with the plurality of pre-determined content corrections.

19. The non-transitory computer-readable medium of claim 17, wherein the instructions of determining whether the one or more of the plurality of pre-determined content corrections are configured to correct the first content error further cause the processor to:
apply the one or more of the plurality of pre-determined content corrections to the first content error in the simulated environment, wherein if the one or more of the plurality of pre-determined content corrections is configured to correct the first content error in the simulated environment, the instructions when executed by the processor cause the processor to:
generate the modified interaction data by applying the one or more of the plurality of pre-determined content corrections to the first content error; and
process the modified interaction data using the one or more software applications in the interaction validation pathway;
wherein if the one or more of the plurality of pre-determined content corrections is not configured to correct the first content error in the simulated environment, the processor is configured to generate the first content correction using the machine learning model.

20. The non-transitory computer-readable medium of claim 17, wherein if the first content correction generated by the machine learning model is not configured to correct the first content error in the simulated environment, the instructions when executed by the processor cause the processor to:
generate a second content correction using the machine learning model;
apply the second content correction to the first content error in the simulated environment; and
determine whether the second content correction is configured to correct the first content error in the simulated environment, wherein if the second content correction is configured to correct the first content error in the simulated environment, the instructions when executed by the processor cause the processor to:
generate the modified interaction data by applying the second content correction to the first content error in the interaction data; and
process the modified interaction data using the one or more software applications in the interaction validation pathway.
